(19) United States
(12) Patent Application Publication
(10) Pub. No.: US 2014/0231539 A1
(43) Pub. Date: Aug. 21, 2014

(54) LIQUID NEBULIZING ASSEMBLY WITH SOLID NOZZLE PLATE

(71) Applicant: MICRO BASE TECHNOLOGY CORPORATION, Bade City (TW)

(72) Inventors: Shu-Pin HSIEH, Bade City (TW); Yung-Hsing TUNG, Bade City (TW); Chien-Hua LIN, Bade City (TW); Yu-Chung HSU, Bade City (TW); Tsai-Tai CHANG, Bade City (TW)

(73) Assignee: MICRO BASE TECHNOLOGY CORPORATION, Bade City (TW)

(21) Appl. No.: 14/149,813

(22) Filed: Jan. 8, 2014

(30) Foreign Application Priority Data
Feb. 19, 2013 (TW) 102105747

(51) Int. Cl. B05B 17/00

(52) U.S. Cl. CPC B05B 17/0646
USPC 239/102.2

(57) ABSTRACT

A liquid nebulizing assembly includes an actuating ring plate, a solid nozzle plate and a piezoelectric element. A plurality of nozzle holes is formed and distributed all over the solid nozzle plate and included between the actuating ring plate and the piezoelectric element. The solid nozzle plate includes at least one reinforcing portion in a 3D shape, and continuously and uninterruptably protruded to form at least one ring-shaped solid with respect to the center of the solid nozzle plate. The assembly is applicable to a relatively ductile and thin material to reduce the power consumption for the vibration transmission and achieve power saving.

### CROSS-REFERENCE TO RELATED APPLICATIONS

This non-provisional application claims priority under 35 U.S.C. §119(a) on Patent Application No(s). 102105747 filed in Taiwan, R.O.C. on Feb. 19, 2013, the entire contents of which are hereby incorporated by reference.

### BACKGROUND OF THE INVENTION

1. Field of the Invention

The present invention generally relates to the field of nebulizers, in particular to the liquid nebulizing assembly with a solid nozzle plate.

2. Description of the Related Art

Since a liquid nebulizing device has aromatic and spray functions, it is used extensively in the fields of medical care and cosmetics, and it also can be used for moisturizing an environment to balance the humidity of the environment in area with a relatively dry weather. In general, there are three main types of liquid nebulizing modules used in the liquid nebulizing device including a module using a pressurization device, a module using the high-frequency oscillation of an ultrasonic element, and a module using the high-frequency oscillation of a piezoelectric element, wherein the liquid nebulizing module using the piezoelectric element for the nebulization mainly relies on a piezoelectric element, and a reverse piezoelectric effect is used to convert electric power into vibration force to generate high-frequency micro-amplitude vibration waves to form vector mist, and the Brownian motion effect drives the air to be mixed with an essence.

With reference to FIG. 1 for a schematic view of a conventional nebulizing device using a piezoelectric element, the nebulizing device using the piezoelectric element generally comprises a nozzle plate P11, an actuating ring plate P12 and a piezoelectric element P13. The nozzle plate P11 is made of metal, and the actuating ring plate P12 is provided for carrying and fixing the nozzle plate P11, and the piezoelectric element P13 is disposed on a side of the actuating ring plate P12. When use, an electric field is applied to the piezoelectric element P13, such that the piezoelectric element P13 produces high-frequency vibration waves, and the nozzle plate P11 is linked by the piezoelectric element P13 and vibrated to produce a deformation or bending to break up the molecular structure of the liquid and produce a nebulization effect to spray out the liquid.

At present, a common nozzle plate P11 available in the market can be divided into two main types, a nozzle plate and a nozzle plate with a plurality of protrusions. For a flat nozzle plate, when the piezoelectric element P13 is vibrated, the vibration energy of the piezoelectric element P13 is transmitted in a direction from the external periphery to the center of the nozzle plate P11. The effect of transmitting the vibration energy is poor due to the limitation of the flat nozzle plate. Since only a small portion adjacent to the center of the nozzle plate P11 can serve as the nebulization area, therefore most of the nozzle plates P11 are made of a material with a higher rigidity or manufactured with a greater thickness, and the vibration energy can be transmitted to the center of the nozzle plate P11 successfully to increase the nebulization area. On the other hand, it is necessary to increase the energy for driving the piezoelectric element P13 that also consumes more energy.

The nozzle plate having a plurality of protrusions can provide a better nebulization effect through the protrusions and increase the nebulization area. However, actual measurements indicate that the vibration energy cannot be transmitted to a planar area besides the protrusions in the process of transmitting the vibration energy by the piezoelectric element P13, and a different amount of vibration energy is transmitted to a different area to cause an uneven nebulization. Therefore, the protrusions and their shape contrarily affect the original vibration energy transmission ways, so the nebulization area and rates are not more effective. Obviously, the conventional nebulizing device requires further improvements.

### SUMMARY OF THE INVENTION

In view of the aforementioned problems of the prior art, it is a primary objective of the present invention to provide a liquid nebulizing assembly with a solid nozzle plate, wherein the liquid nebulizing assembly is installed at at least one reinforcing portion to increase the structural strength without affecting the vibration energy transmission ways, and increase the nebulization area.

A secondary objective of the present invention is to provide a liquid nebulizing assembly with a solid nozzle plate, wherein the liquid nebulizing assembly is applicable for a softer and thinner material to achieve the effects of improving the vibration transmission capability, reducing the power consumption for transmitting the vibration, and saving energy.

To achieve the foregoing objectives, the present invention provides a liquid nebulizing assembly with a solid nozzle plate for sealing an opening of a chamber, and the liquid nebulizing assembly comprises an actuating ring plate, the solid nozzle plate and a piezoelectric element, and the actuating ring plate is disposed on a side of the piezoelectric element, characterized in that a plurality of nozzle holes is formed and distributed all over the solid nozzle plate, and the solid nozzle plate is included between the actuating ring plate and the piezoelectric element, and the solid nozzle plate includes at least one reinforcing portion in a three dimensional geometric solid shape, and the at least one reinforcing portion is continuously and uninterruptably protruded to form at least one ring-shaped solid by using the center of the solid nozzle plate as a basis; such that when the liquid nebulizing assembly is used, the vibration energy of the piezoelectric element is not concentrated at the center of the solid nozzle plate due to the reinforcing portion, and the vibration energy is distributed uniformly to each corner of the solid nozzle plate to increase a nebulization area.

It is noteworthy that the ring-shaped solid can be a convex ring-shaped solid, a concave ring-shaped solid, or a combination of the convex ring-shaped solid and the concave ring-shaped solid, such that the vibration energy can be transmitted to each corner of the solid nozzle plate uniformly to increase the nebulization area significantly.

In addition, the reinforcing portion is protruded from a side of the solid nozzle plate, and the other side of the three dimensional geometric solid ring plate is a plane, or the other side of the solid nozzle plate is corresponsive to the reinforcing portion to form a concave surface, and the reinforcing portion has a cross-section in a triangular shape, a semicircular shape or a rectangular shape.

The liquid nebulizing assembly with a solid nozzle plate further comprises an energy transmission element and a penetrating hole formed at the center of the energy transmission element, and the energy transmission element is disposed between the actuating ring plate and the piezoelectric element, such that the solid nozzle plate is clamped and fixed between the energy transmission element and the actuating ring plate.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a schematic view of a conventional nebulizing device with a piezoelectric element;

FIG. 2A is a top view of a liquid nebulizing assembly with a solid nozzle plate in accordance with a first preferred embodiment of the present invention;

FIG. 2B is a sectional side view of a liquid nebulizing assembly with a solid nozzle plate in accordance with the first preferred embodiment of the present invention;

FIGS. 3A-3D are sectional side views of different shaped solid ring of the present invention;

FIGS. 4A-4D are sectional side views of different modes of thin films of the present invention;

FIG. 5 is a schematic view of a liquid nebulizing assembly with a solid nozzle plate in accordance with a second preferred embodiment of the present invention; and

FIGS. 6A-6F are top views of thin films of different modes of the present invention.

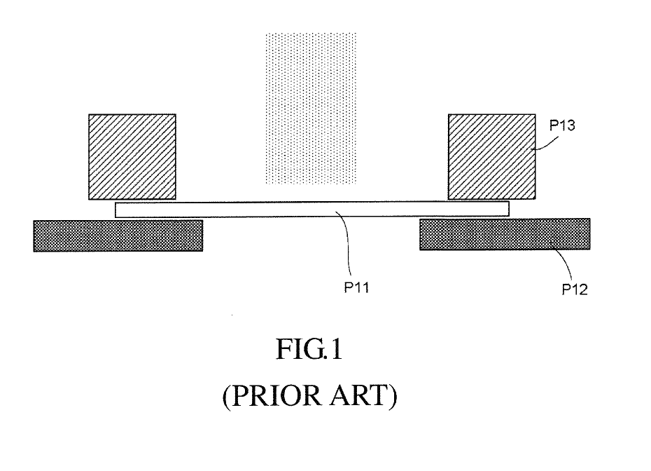

### DETAILED DESCRIPTION OF THE PREFERRED EMBODIMENTS

The technical content of the present invention will become apparent by the detailed description of the following embodiments and the illustration of related drawings as follows.

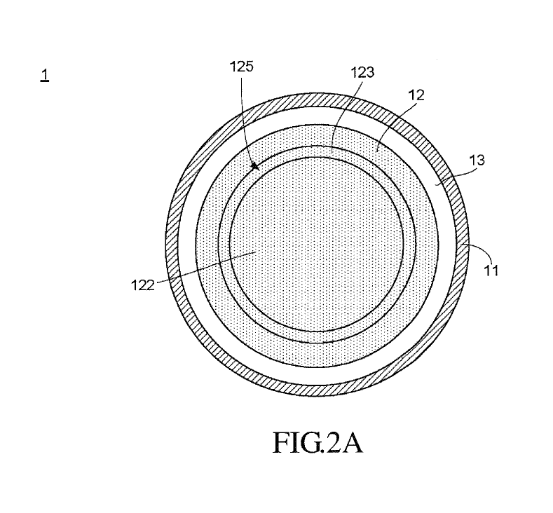

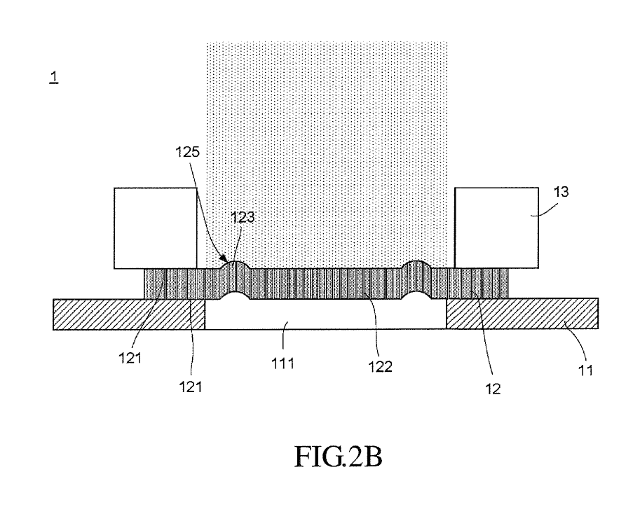

With reference to FIGS. 2A and 2B for a bottom view and a sectional side view of a liquid nebulizing assembly with a solid nozzle plate in accordance with the first preferred embodiment of the present invention respectively, the liquid nebulizing assembly with a solid nozzle plate 1 for sealing an opening of a chamber (not shown in the figure) comprises an actuating ring plate 11, the solid nozzle plate 12 and a piezoelectric element 13.

Wherein, the actuating ring plate 11 is a thin flat ring-shaped solid 125 with a first through hole 111 formed at the center of the actuating ring plate 11.

The solid nozzle plate 12 is a circular disc structure made of a non-metal selected from the group consisting of polyimide, polyethylene (PE), polypropylene (PP) and polyetheretherketone (PEEK) and any advanced engineering plastic, or a metal, wherein a fixing portion 121 is disposed at the periphery of the solid nozzle plate 12 and clamped between the actuating ring plate 11 and the piezoelectric element 13, and a plurality of nozzle holes 122 is distributed all over the whole solid nozzle plate 12. The solid nozzle plate 12 includes a reinforcing portion 123 which is a single ring-shaped solid 125, so that the reinforcing portion 123 also has the nozzle holes 122 formed thereon and is formed of continuous protrusions surrounding the center of the solid nozzle plate 12 to form at least one ring-shaped solid 125. In FIG. 2B, the reinforcing portion 123 protrudes from the nozzle plate to the piezoelectric element 13 side and the reinforcing portion 123 is protruded from a side of the solid nozzle plate 12 and has a height greater than the plane around. Compared with the plane around, the reinforcing portion 123 can enhance the structural strength effectively, and the ring-shaped solid 125 is continuous and uninterruptable, so that it will not affect the vibration energy transmission ways, and the utility of the nebulization area of the solid nozzle plate 12 can be maximized. It is noteworthy that the solid nozzle plate 12 is in a circular shape, a rectangular shape or a polygonal shape; and the solid nozzle plate 12 is clamped and fixed by the actuating ring plate 11 and the piezoelectric element 13 at the fixing portion 121 near the periphery, and a side of the reinforcing portion 123 and the nozzle holes 122 are aligned inside the area of the first through hole 111. In addition, the distribution area of the reinforcing portion 123 is equal to 3%-90% of the total area of the solid nozzle plate.

The piezoelectric element 13 is made of a piezoelectric ceramic material composed of lead zirconate titanate, and the piezoelectric element 13 is disposed on a side of the actuating ring plate 11, and an opening (not labeled in the figure) is formed at the center of the piezoelectric element 13 and disposed at a position corresponding to the first through hole 111, and the other side of the reinforcing portion 123 and the nozzle holes 122 are aligned inside the area of the opening.

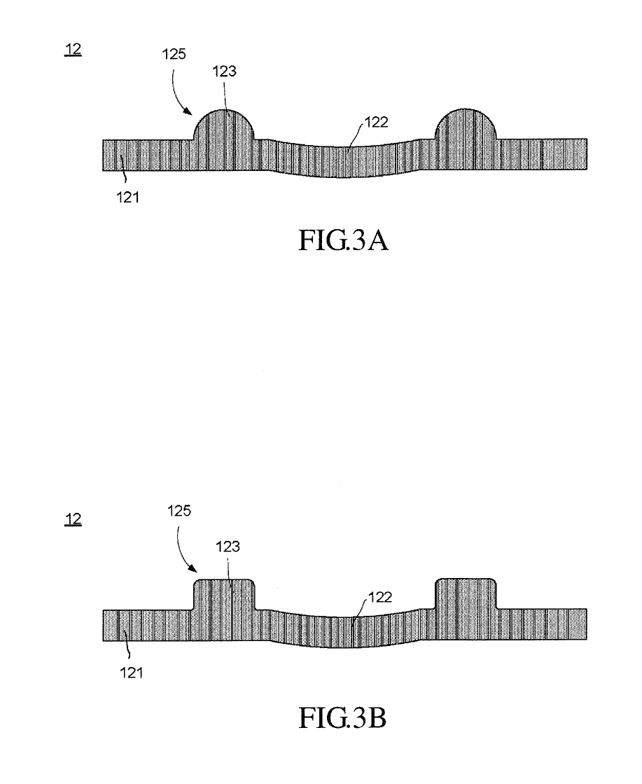

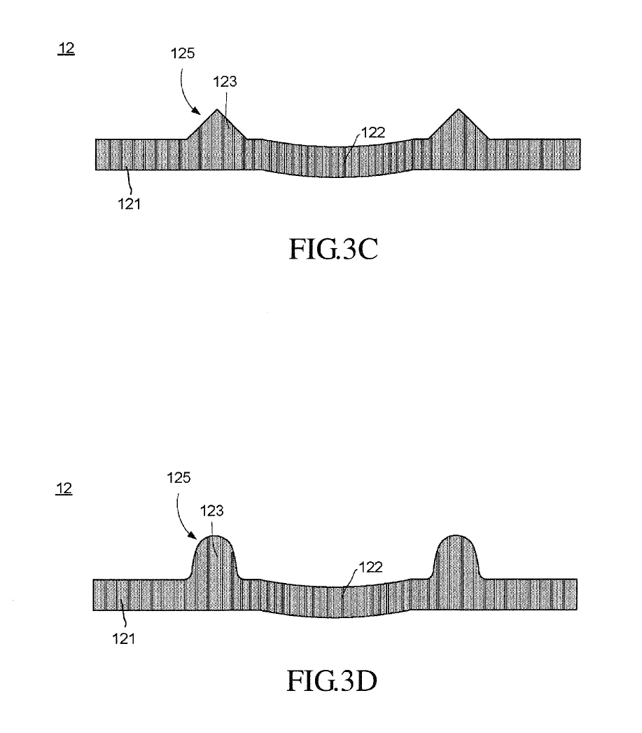

With reference to FIGS. 3A-3D for sectional side views of solid nozzle plates of different shapes in accordance with the present invention respectively, the reinforcing portion 123 is a protrusion protruded from the solid nozzle plate 12. In other words, the sectional shape of the reinforcing portion 123 can be a semicircular shape (as shown in FIG. 3A), a rectangular shape (as shown in FIG. 3B), a triangular shape (as shown in FIG. 3C) or a semi-elliptical shape (as shown in FIG. 3D) and the other side of the 3D geometric solid ring plate 12 is a flat plane. In addition, the solid nozzle plate 12 is disposed at a position corresponding to the nozzle holes 122 and has a convex surface 124 protruded in a direction opposite to the reinforcing portion 123.

When turning on and inputting a voltage to the piezoelectric element 13, the piezoelectric element 13 is stretched, contracted and deformed repeatedly. And then electrical energy is transmitted in faint of vibration waves to the solid nozzle plate 12 so as to vibrate the solid nozzle plate 12. Compared with the conventional flat nozzle plate, the solid nozzle plate 12 of the present invention can enhance the rigidity of the original planar structure by means of the reinforcing portion 123, and eliminate the frequency of resonances occurred at a low-frequency side, so that the solid nozzle plate 12 is in a more precise high-frequency vibration mode, and the vibration energy of the piezoelectric element 13 can be concentrated and converted into high-frequency spray energy without causing energy loss due to the low-frequency vibration. In addition, the reinforcing portion 123 is a solid reinforcing structure that plays the role of human skeleton to provide a supporting function. Therefore, the liquid nebulizing assembly of the invention is applicable for a relatively ductile and thin material (approximately from 20 um to 125 um), and the vibration energy of the piezoelectric element 13 can be transmitted to every position of the solid nozzle plate 12 more easily and uniform without affecting the vibration energy transmission ways, so as to achieve the effects of maximizing the utility of the solid nozzle plate 12 with the nozzle holes 122, increasing the nebulization area and the spray range effectively, and providing a uniform nebulization. In addition, some factors affecting the nebulization effect of the solid nozzle plate 12 depend on the high-frequency vibration, particularly to the upper and lower displacements at the positions of the nozzle holes 122. Compared with the conventional flat nebulization plate, the solid nozzle plate 12 of the present invention can provide a more appropriate deformation requirement for the upper and lower displacement at the positions of the nozzle holes 122 in a high-frequency oscillation to improve the vibration amplitude and the nebulization effect significantly.

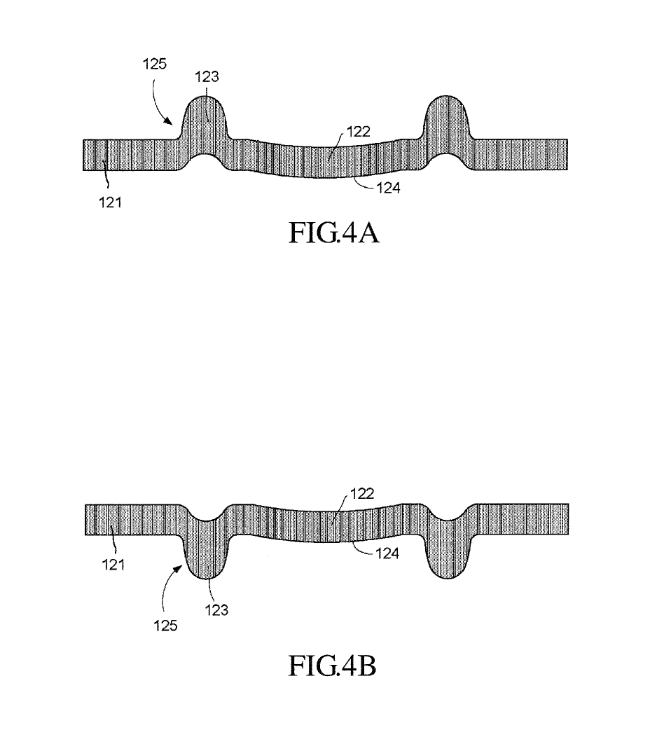

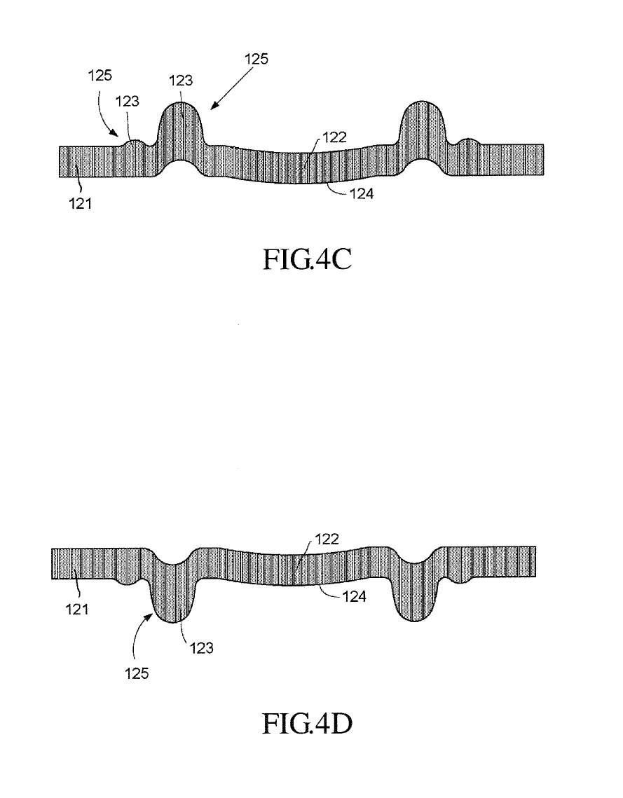

With reference to FIGS. 4A-4D for sectional side views of different modes of thin films of the present invention respectively, FIG. 4A shows that the reinforcing portion 123 is protruded from a side of the solid nozzle plate 12, and the other side of the solid nozzle plate 12 is corresponsive to the reinforcing portion 123 to form a concave surface. Although the reinforcing portion 123 is in a different form, it still would be helpful to transmit vibration force. In FIG. 4B, the form of the reinforcing portion 123 is the same as the form as shown in FIG. 4A except that the protruding direction is the same as the protruding direction of the convex surface 124. In FIG. 4C, there is a plurality of reinforcing portions 123. In FIG. 4C, there are two reinforcing portions 123, and their protruding directions are the same. It is noteworthy that the height and width of the reinforcing portions 123 can be adjusted according to requirements. In FIG. 4D, the protruding direction of the reinforcing portions 123 as shown in FIG. 4C is transposed, such that the protruding direction is the same as the protruding direction of the convex surface 124.

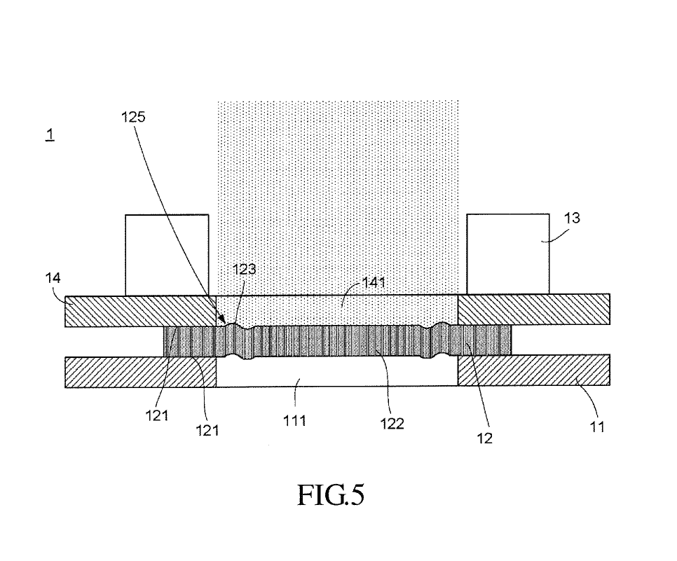

With reference to FIG. 5 for a schematic view of a liquid nebulizing assembly with a solid nozzle plate in accordance with the second preferred embodiment of the present invention (please also refer to FIG. 2B), the main components of the second preferred embodiment are the same as those of the first preferred embodiment except that the liquid nebulizing assembly with a solid nozzle plate 1 further comprises an energy transmission element 14, and a second through hole 141 formed at the center of the energy transmission element; and the energy transmission element is disposed between the actuating ring plate 11 and the piezoelectric element 13, such that the solid nozzle plate 12 is clamped between the energy transmission element 14 and the actuating ring plate 11, and the energy transmission element 14 can be utilized to enhance the effect of transmitting a vibration force by the piezoelectric element 13 and fixing the solid nozzle plate 12 stably. In addition, the reinforcing portions 123 can be plural in quantity. As shown in the figure, the reinforcing portions 123 are two ring-shaped solids 125, and the two ring-shaped solids 125 are disposed concentrically with each other to improve the nebulization effect and increase the nebulization area.

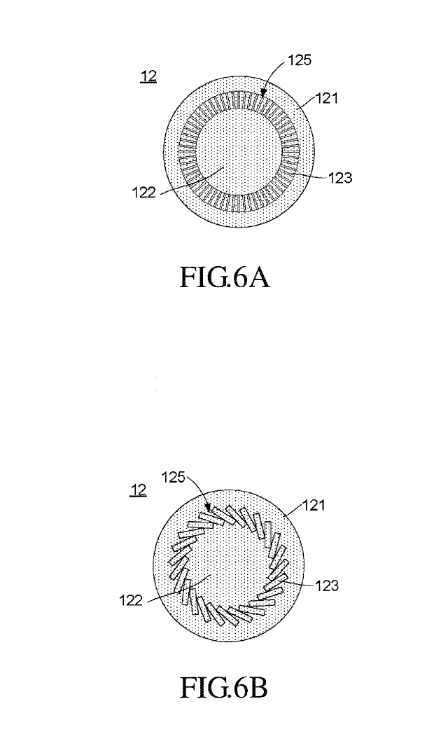

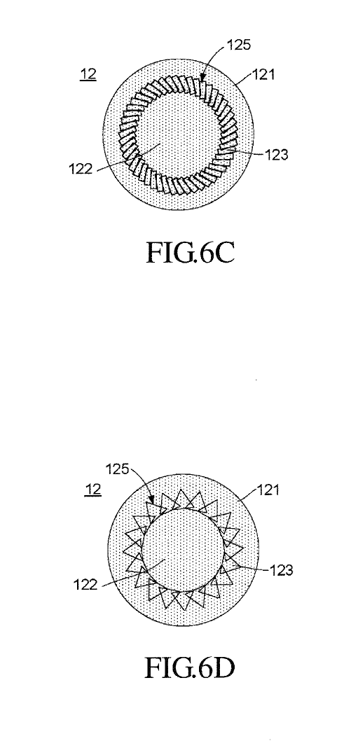

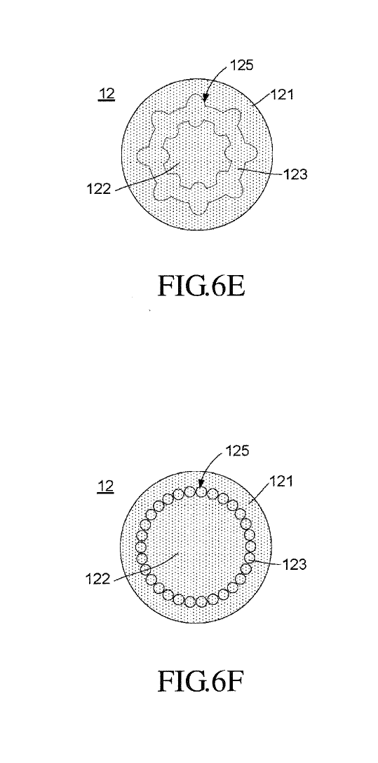

With reference to FIGS. 6A-6F for top views of solid nozzle plates of different modes in accordance with the present invention respectively, various types of reinforcing portions 123 of the solid nozzle plate 12 are arranged into different shapes, and adjacent reinforcing portions 123 are continuously protrusions which form a ring-shaped solid 125 as shown in FIG. 6A, and all of the reinforcing portions 123 are in a rectangular shape, and edges of the reinforcing portions are connected to form the ring-shaped solid 125, and the reinforcing portions 123 is disposed between the fixing portion 121 and the nozzle holes 122. In FIG. 6B, all of the reinforcing portions 123 are in a rectangular shape and the reinforcing portions 123 are deflected through an angle and then adjacent edges of the reinforcing portions 123 are connected to form the ring-shaped solid 125. The reinforcing portions 123 are also disposed between the fixing portion 121 and the nozzle holes 122. In FIG. 6C, all of the reinforcing portions 123 are in a rectangular shape, and the reinforcing portions 123 are deflected through an angle, and then adjacent edges are superimposed and connected to form the ring-shaped solid 125, and the reinforcing portions 123 are also disposed between the fixing portion 121 and the nozzle holes 122. In FIG. 6D, the reinforcing portions 123 is in a triangular shape, and the reinforcing portions 123 are deflected through an angle, and the vertices of the reinforcing portions are superimposed and connected to form the ring-shaped solid 125, and the reinforcing portions 123 is disposed between the fixing portion 121 and the nozzle holes 122. In FIG. 6E, the reinforcing portions 123 have a plurality of ovals disposed on a ring-shape, and an end of the ovals faces the center of the solid nozzle plate 12, and the other end is an outwardly radiated ring-shaped solid 125, and the reinforcing portion 123 is also disposed between the fixing portion 121 and the nozzle holes 122. In FIG. 6F, the reinforcing portions 123 are all in a circular shape, and adjacent borders are connected to form the ring-shaped solid 125, and the reinforcing portion 123 is also disposed between the fixing portion 121 and the nozzle holes 122.

What is claimed is:

1. A liquid nebulizing assembly with a solid nozzle plate, for sealing an opening of a chamber, comprising an actuating ring plate, the solid nozzle plate and a piezoelectric element, and the actuating ring plate being disposed on a side of the piezoelectric element, characterized in that a plurality of nozzle holes is formed and distributed all over the solid nozzle plate, and the solid nozzle plate is included between the actuating ring plate and the piezoelectric element, and the solid nozzle plate includes at least one reinforcing portion in a three dimensional geometric solid shape, and the at least one reinforcing portion is formed by continuous protrusions which form a ring-shaped solid relative to the center of the solid nozzle plate; such that when the liquid nebulizing assembly is used, the vibration energy of the piezoelectric element is not concentrated at the center of the solid nozzle plate due to the reinforcing portion, and the vibration energy is distributed uniformly to whole surface of the solid nozzle plate to increase a nebulization area.

2. The liquid nebulizing assembly with a solid nozzle plate according to claim 1, wherein the reinforcing portion is distributed in an area equal to 3%-90% of the total area.

3. The liquid nebulizing assembly with a solid nozzle plate according to claim 2, wherein the reinforcing portion is a ring-shaped solid.

4. The liquid nebulizing assembly with a solid nozzle plate according to claim 2, wherein the adjacent reinforcing portions are continuous protrusions to form a ring-shaped solid.

5. The liquid nebulizing assembly with a solid nozzle plate according to claim 4, wherein all of the reinforcing portions are in a rectangular shape, and edges of the adjacent reinforcing portions are connected to form the ring-shaped solid, and the reinforcing portions are disposed between the fixing portion and the nozzle holes.

6. The liquid nebulizing assembly with a solid nozzle plate according to claim 4, wherein all of the reinforcing portions are in a rectangular shape, and the reinforcing portions are deflected by an angle and edges of the adjacent reinforcing portions are connected to form a ring-shape, and the reinforcing portions are disposed between the fixing portion and the nozzle holes.

7. The liquid nebulizing assembly with a solid nozzle plate according to claim 4, wherein all of the reinforcing portions are in a rectangular shape, and the reinforcing portions are deflected by an angle, and then edges of the reinforcing portions are superimposed and connected to form the ring-shaped solid, and the reinforcing portions are disposed between the fixing portion and the nozzle holes.

8. The liquid nebulizing assembly with a solid nozzle plate according to claim 4, wherein all of the reinforcing portions are in a triangular shape, and the reinforcing portions are deflected by an angle, and then vertices of the reinforcing portions are superimposed and connected to form the ring-shaped solid, and the reinforcing portions are disposed between the fixing portion and the nozzle holes.

9. The liquid nebulizing assembly with a solid nozzle plate according to claim 4, wherein the reinforcing portions include a plurality of ovals on the ring-shape solid, and an end of the ovals faces the center of the solid nozzle plate, and the other end of the ovals is the outwardly radiated, and the reinforcing portions are disposed between the fixing portion and the nozzle holes.

10. The liquid nebulizing assembly with a solid nozzle plate according to claim 4, wherein all of the reinforcing portions are in a circular shapes, and borders of the adjacent reinforcing portions are connected to form the ring-shaped solid, and the reinforcing portions are disposed between the fixing portion and the nozzle holes.

11. The liquid nebulizing assembly with a solid nozzle plate according to claim 4, wherein the solid nozzle plate is in a shape selected from the group consisting of a circular shape, a rectangular shape and a polygonal shape.

12. The liquid nebulizing assembly with a solid nozzle plate according to claim 1, wherein the reinforcing portion is in a shape selected from the group consisting of a triangular shape, a semicircular shape and a rectangular shape.

13. The liquid nebulizing assembly with a solid nozzle plate according to claim 4, wherein the reinforcing portion is in a shape selected from the group consisting of a triangular shape, a semicircular shape and a rectangular shape.

14. The liquid nebulizing assembly with a solid nozzle plate according to claim 1, wherein the reinforcing portion is protruded from a side of the solid nozzle plate, and the other side of the three dimensional geometric solid ring plate is a flat plane.

15. The liquid nebulizing assembly with a solid nozzle plate according to claim 4, wherein the reinforcing portion is protruded from a side of the solid nozzle plate, and the other side of the three dimensional geometric solid ring plate is a flat plane.

16. The liquid nebulizing assembly with a solid nozzle plate according to claim 1, wherein the reinforcing portion is protruded from a side of the solid nozzle plate, and the other side of the solid nozzle plate is corresponsive to the reinforcing portion to form a concave surface.

17. The liquid nebulizing assembly with a solid nozzle plate according to claim 4, wherein the reinforcing portion is protruded from a side of the solid nozzle plate, and the other side of the solid nozzle plate is corresponsive to the reinforcing portion to form a concave surface.

18. The liquid nebulizing assembly with a solid nozzle plate according to claim 1, wherein the solid nozzle plate is made of a material selected from the group consisting of polyimide, polyethylene (PE), polypropylene (PP), polyetheretherketone (PEEK) and any advanced engineering plastic and metal.

19. The liquid nebulizing assembly with a solid nozzle plate according to claim 1, further comprising an energy transmission element with a penetrating hole formed at the center of the energy transmission element, and the energy transmission element being disposed between the actuating ring plate and the piezoelectric element, such that the solid nozzle plate is clamped between the energy transmission element and the actuating ring plate.
